(19) United States
(12) Patent Application Publication
(10) Pub. No.: US 2010/0045005 A1
(43) Pub. Date: Feb. 25, 2010

(54) THREE DOOR AIR BAG CHUTE

(76) Inventor: ALAN H. AUGUSTYNIAK, Clarkston, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(21) Appl. No.: 12/197,665

(22) Filed: Aug. 25, 2008

(51) Int. Cl. B60R 21/20

(52) U.S. Cl. 280/728.3

(57) ABSTRACT

A combination positionable in an interior of a motor vehicle is disclosed herein. The combination includes an instrument panel having a body extending along a lateral axis between an outboard side and an inboard side. The body has an outwardly-facing surface for display in a passenger compartment of a motor vehicle and an inwardly-facing surface opposite the outwardly-facing surface. The combination also includes a score pattern formed in the inwardly-facing surface and defining three regions. Each region is less than fully surrounded by score lines. The combination also includes an inflatable restraint disposed adjacent the inwardly-facing surface at the score pattern. The inflatable restraint is operable to burst through the body upon engagement and thereby convert the three regions into first and second and third doors in the body. The first door is operable to pivot open along a first axis substantially parallel to the lateral axis and the second and third doors are operable to pivot open along respective second and third axes each being substantially transverse to the lateral axis. The combination also includes a vehicle seat operable for adjustable movement relative to the instrument panel. The vehicle seat and the score pattern are positionable relative to one another such that none of the first and second and third doors contact a head of an out-of-position six-year-old anthropomorphic dummy during testing.

### BACKGROUND OF THE INVENTION

1. Field of the Invention

This invention relates in general to air bags generally and to the arrangement of doors for an air bag in particular.

2. Description of Related Art

When the inflatable restraint is activated, the expanding restraint can burst through the instrument panel, forming doors in the instrument panel. The doors thus-formed could interact with a passenger of the vehicle. The Federal Motor Vehicle Safety Standard & Regulations specifies performance requirements for motor vehicles generally and the performance of restraints systems in particular. Standard No. 208 (49 CFR 571.208) addresses the protection of vehicle occupants in crashes specifies vehicle crashworthiness requirements. These requirements are defined in terms of forces and accelerations applied to anthropomorphic dummies in test crashes. Sub-sections 14, 23 and 24 of Standard No. 208 detail advanced air bag requirements for passenger cars and trucks. More particularly, these sub-sections relate to the performance of an inflatable restraint when a child is in the front seat. The standards contemplate the situation where a six-year-old child is out-of-position. Subsection 24.4.3 details a test for such a condition, in particular when the six-year-old child's head or torso is contacting the instrument panel. Under the test, the dummy's head will be positioned in proximity to the portion of the instrument panel that will burst open when the inflatable restraint activates.

FIG. 1 illustrates an arrangement in the prior art. An instrument panel is positioned in the interior 12 of a vehicle. A windshield 14 of the vehicle is also shown for reference. An inflatable restraint assembly 16 is disposed to provide an air bag to the interior 12 in the event of a collision. The assembly 16 includes a reaction canister 18 to contained the air bag prior to inflation. A door panel assembly 20 covers the reaction canister 18. A door chute assembly 22 extends between the door panel assembly 20 and the instrument panel 10. The door chute assembly 22 is mechanically bonded to the instrument panel and defines first and second doors 24, 26. When the air bag inflates, the doors 24, 26 can pivot about respective hinge axes 28, 30 to an open position. The door chute assembly 22 also includes first and second bellows portions 32, 34; upon opening of the doors 24, 26, the first and second bellows portions 32, 34 can be straightened.

FIG. 1 shows that portions of the instrument panel 10 remain attached to the doors 24, 26 during pivoting a movement; a portion 36 of the instrument panel 10 remains attached to the door 24 and a portion 38 of the instrument panel 10 remains attached to the door 26. The combined portion 36 and door 24 are designated a door assembly 40 and the combined portion 38 and door 26 are designated a door assembly 42. It is noted that the door assemblies 40, 42 are each shown in three different positions in FIG. 1, a closed position, an open position, and a position intermediate of the closed and open positions.

A dashed line 44 is shown in FIG. 1 and represents the position of the head of a six-year-old anthropomorphic dummy. A “six-year-old anthropomorphic dummy” is a dummy that corresponds in size and shape and weight to the body of a six-year-old child. The dummy is “out-of-position” according to the test parameters. The position of the head will be determined by the government standards identified above in view of the physical dimensions and properties of the vehicle seat. As shown in FIG. 1, an edge 48 of the door assembly 42 will follow an arcuate path 46 during movement occasioned by inflation of the air bag. The path 46 intersects the line 44; the edge 48 will contact the head of a six-year-old anthropomorphic dummy.

### SUMMARY OF THE INVENTION

In summary, the invention is a combination positionable in an interior of a motor vehicle. The combination includes an instrument panel having a body extending along a lateral axis between an outboard side and an inboard side. The body has an outwardly-facing surface for display in a passenger compartment of a motor vehicle and an inwardly-facing surface opposite the outwardly-facing surface. The combination also includes a score pattern formed in the inwardly-facing surface and defining three regions. Each region is less than fully surrounded by score lines. The combination also includes an inflatable restraint disposed adjacent the inwardly-facing surface at the score pattern. The inflatable restraint is operable to burst through the body upon engagement and thereby convert the three regions into first and second and third doors in the body. The first door is operable to pivot open along a first axis substantially parallel to the lateral axis and the second and third doors are operable to pivot open along respective second and third axes each being substantially transverse to the lateral axis. The combination also includes a vehicle seat operable for adjustable movement relative to the instrument panel. The vehicle seat and the score pattern are positionable relative to one another such that none of the first and second and third doors contact a head of an out-of-position six-year-old anthropomorphic dummy during testing.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a cross-sectional view of an arrangement in the prior art, the cross-section being taken in plane parallel to a longitudinal axis of a vehicle;

FIG. 2 is a cross-sectional view of the exemplary embodiment of the invention taken in plane parallel to a longitudinal axis of a vehicle;

FIG. 3 is a top view of an instrument panel of the exemplary embodiment of the invention showing a score pattern; and

FIG. 4 is a perspective view of a door chute assembly according to the exemplary embodiment of the invention.

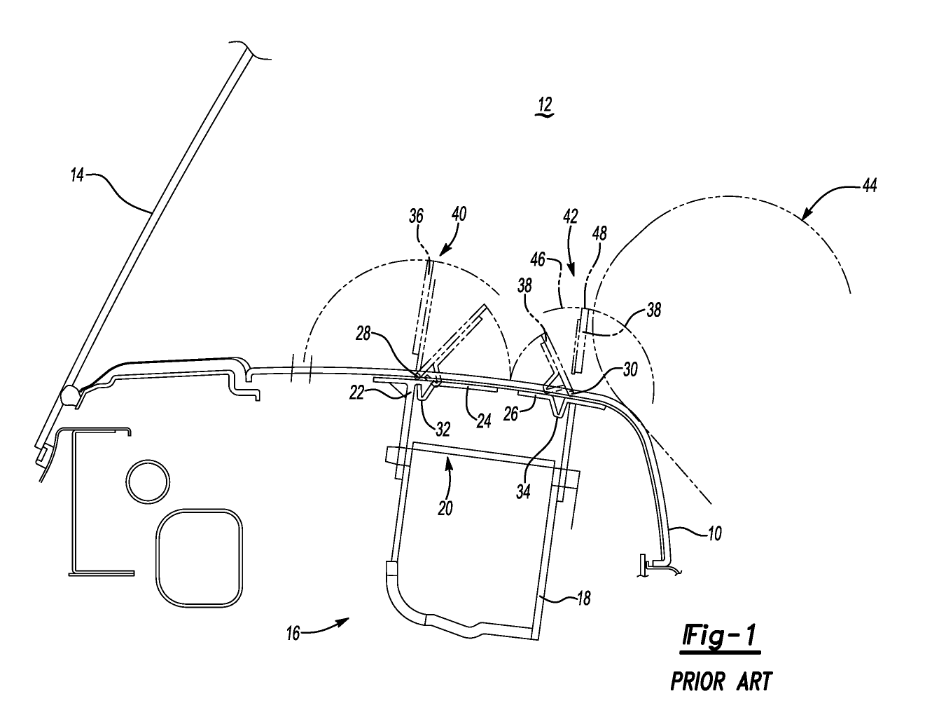

### DETAILED DESCRIPTION OF THE PREFERRED EMBODIMENT

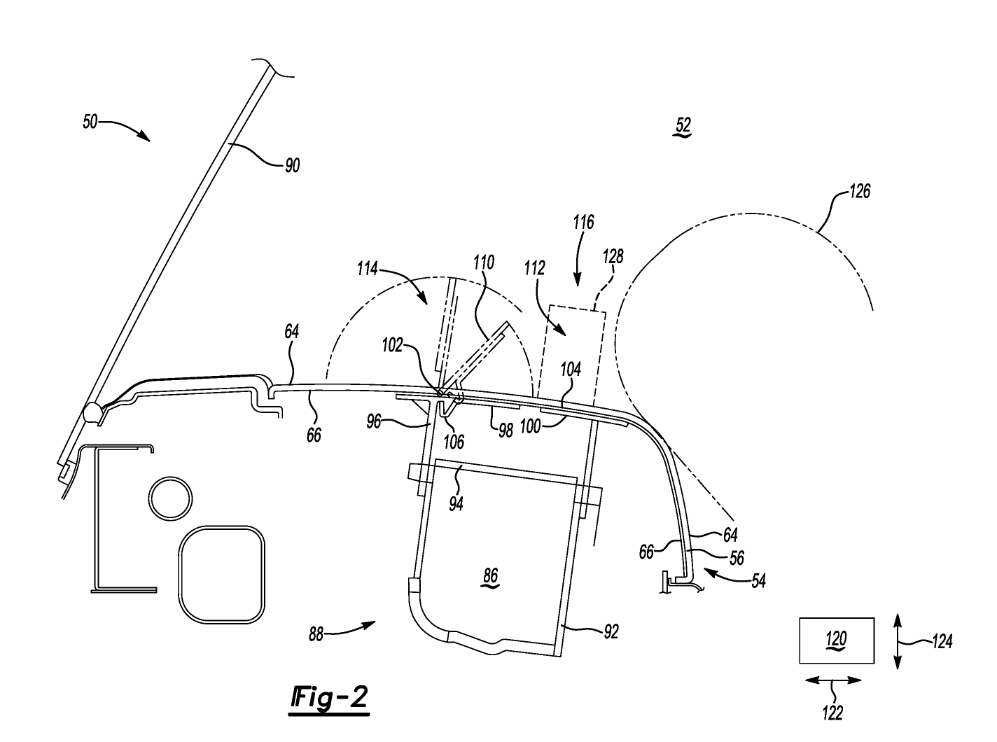

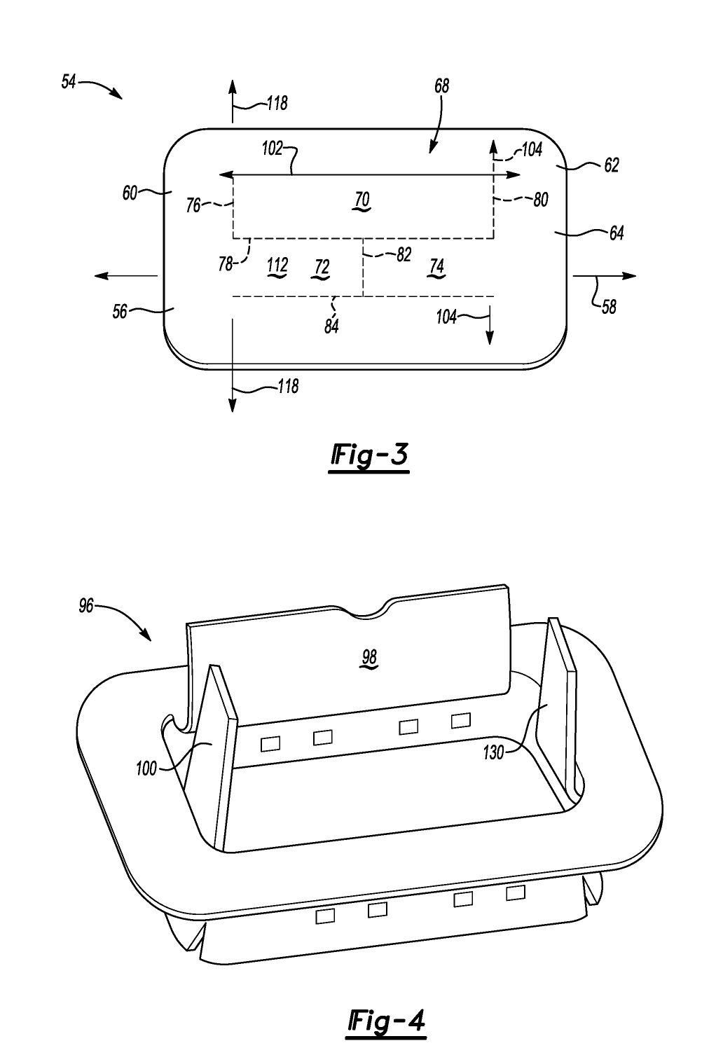

Referring now to FIG. 2, the invention is embodied by example and not limitation in a combination 50 positionable in an interior 52 of a motor vehicle. A windshield 90 of the vehicle is also shown for reference. The combination 50 includes an instrument panel 54 having a body 56. In the exemplary embodiment of the invention, windshield 90 is disposed in fixedly-spaced relation to the instrument panel 54. FIG. 3 shows a top view of the instrument panel 54 and shows the body 56 extending along a lateral axis 58 between an outboard side 60 and an inboard side 62. The lateral axis 58 extends transverse to a longitudinal axis of the vehicle.

The body 56 has an outwardly-facing surface 64 for display in a passenger compartment or interior 52 of a motor vehicle and an inwardly-facing surface 66 opposite the outwardly-facing surface 64. Referring again to FIG. 3, the combination 50 also includes a score pattern 68 formed in the inwardly-facing surface 66 and defining three regions 70, 72, 74. FIG. 3 shows the score pattern 68 in dash line since the score pattern 68 is defined on the inwardly-facing surface 66 and therefore hidden in FIG. 3.

Each region 70, 72, 74 is less than fully surrounded by score lines. The region 70 is partially surrounded by score lines 76, 78, 80. The region 72 is partially surrounded by a portion of the score line 78, a score line 82, and a portion of a score line 84. In the exemplary embodiment of the invention, the score lines 78 and 84 extend substantially parallel to one another and parallel to the lateral axis 58. However the score lines 78 & 84 can be unparallel based on factors related to surface geometry, position of windshield 90, position of the head of a six-year-old anthropomorphic dummy 126 and or desired dynamic performance of the airbag. The region 74 is partially surrounded by a portion of the score line 78, the score line 82, and a portion of the score line 84. In the exemplary embodiment of the invention, score lines 76, 80 and 82 extend substantially parallel to one another and transverse to the lateral axis 58. Likewise score lines 76, 80 and 82 can also be unparallel for the same reasons. The score line 82 is disposed closer to the vehicle seat 120 than the score lines 76, 80. In the exemplary embodiment of the invention, the score line 84 is disposed closer to the vehicle seat 120 than the score line 78 and the score lines 76, 80.

Referring again to FIG. 2, the combination 50 also includes an inflatable restraint 86 disposed adjacent the inwardly-facing surface 66 at the score pattern 68. The inflatable restraint 86 is operable to burst through the body 56 upon engagement. The inflatable restraint 86 can be an air bag that is part of an inflatable restraint assembly 88. The assembly 88 can include a reaction canister 92 to contained the air bag 86 prior to inflation. A door panel assembly 94 can cover the reaction canister 92. A door chute assembly 96 can extend between the door panel assembly 94 and the instrument panel 54. The door chute assembly 96 can be mechanically bonded to the instrument panel 54 and define first and second doors 98, 100. The door 100 shown in FIG. 2 hides another door, not visible since this door is directly behind the door 100 in this view. FIG. 4 shows a perspective view of the door chute assembly 96 and shows the hidden door 130 defined the door chute assembly 96. When the air bag 86 inflates, the doors 98, 100 and 130 can pivot about respective hinge axes 102, 118 and 104 to an open position. The axis 102 and 104 are transverse to one another, as shown in FIG. 3. The door chute assembly 96 can also include a bellows portion 106; upon opening of the door 98, the bellows portion 106 can be straightened.

Upon inflation, the air bag 86 can burst through the door panel assembly 94, door chute assembly 96, the first, second and third second doors 98, 100, 130, and the instrument panel 54. Portions of the instrument panel 54 remain attached to the doors 98, 100 during pivoting a movement; a portion 110 of the instrument panel 54 remains attached to the door 98 and a portion 112 of the instrument panel 54 remains attached to the door 100. The combined portion 110 and door 98 are designated a door assembly 114 and the combined portion 112 and door 100 are designated a door assembly 116. It is noted that the door assembly 114 is shown in three different positions in FIG. 2, a closed position, an open position, and a position intermediate of the closed and open positions. It is also noted that the door assembly 116 is shown in two different positions in FIG. 2, a closed position and an open position.

Inflation of the air bag 86 can thereby convert the three regions 70, 72, 74 into first and second and third doors in the body 56. The portion 110 is a first door and the portion 112 is a second door. The first door or portion 110 is operable to pivot open along the axis 102 parallel to the lateral axis 58 and the second and third doors are operable to pivot open along respective second and third axes 118 and 104, each being transverse to the lateral axis 58. The term transverse is applied to mean at an angle, perpendicular or non-perpendicular.

The combination 50 also includes a vehicle seat 120 operable for adjustable movement relative to the instrument panel 54. The seat 120 is shown schematically because any configuration of adjustable vehicle seat can be applied in embodiments of the invention. The exemplary seat 120 can be adjusted longitudinally in the vehicle, such as closer to or further from the instrument panel 54; longitudinal adjusting movement is represented by double-arrow 122. The exemplary seat 120 can also be adjusted vertically in the vehicle, such as closer to or further from a floor pan of the vehicle; vertical adjusting movement is represented by double-arrow 124.

A dashed line 126 is shown in FIG. 2 and represents the position of the head of a six-year-old anthropomorphic dummy. A “six-year-old anthropomorphic dummy” is a dummy that corresponds in size and shape and weight to the body of a six-year-old child. The position of the head relative to the instrument panel 54 can be determined by the government standards identified above in view of the physical dimensions and properties of the vehicle seat 120. An edge 128 of the door assembly 116 will follow an arcuate path during movement occasioned by inflation of the air bag 86. This arcuate path 46 is in plane perpendicular to the plane of perspective of FIG. 2. FIG. 2 shows that the edge 128 will not contact the head of an “out-of-position” six-year-old anthropomorphic dummy. The vehicle seat 120 and the score pattern 68 are positioned in the vehicle such that none of the first and second and third doors contact the head of an out-of-position six-year-old anthropomorphic dummy during testing.

In the exemplary embodiment of the invention, the windshield 90 and the score pattern 68 are positioned relative to one another such that none of the first and second and third doors contact the windshield 90 when the inflatable restraint 86 engages.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A combination positionable in an interior of a motor vehicle comprising:
an instrument panel having a body extending along a lateral axis between an outboard side and an inboard side and having an outwardly-facing surface for display in a passenger compartment of a motor vehicle and an inwardly-facing surface opposite said outwardly-facing surface;
a score pattern formed in said inwardly-facing surface and defining three regions wherein each region is less than fully surrounded by score lines;
an inflatable restraint disposed adjacent said inwardly-facing surface at said score pattern and operable to burst through said body upon engagement and thereby convert said three regions into first and second and third doors in said body, said first door being operable to pivot open along a first axis substantially parallel to said lateral axis and said second and third doors being operable to pivot open along respective second and third axes each being substantially transverse to said lateral axis; and
a vehicle seat operable for adjustable movement relative to said instrument panel, said vehicle seat and said score pattern being positionable relative to one another such that none of said first and second and third doors contact a head of an out-of-position six-year-old anthropomorphic dummy during testing.

2. The combination of claim 1 wherein said score pattern further comprises:
first and second score lines extending substantially parallel to one another and substantially parallel to said lateral axis.

3. The combination of claim 2 wherein said score pattern further comprises:
third and fourth and fifth score lines extending substantially parallel to one another and substantially transverse to said lateral axis, wherein one of said third and fourth and fifth score lines is disposed closer to said vehicle seat than the other two of said third and fourth and fifth score lines.

4. The combination of claim 3 wherein one of said first and second score lines is disposed closer to said vehicle seat than the other of said first and second score lines and two of said third and fourth and fifth score lines.

5. The combination of claim 4 further comprising:
a windshield disposed in fixedly-spaced relation to said instrument panel, said windshield and said score pattern being positionable relative to one another such that none of said first and second and third doors contact said windshield when said inflatable restraint engages.
